(19) United States
(12) Patent Application Publication
(10) Pub. No.: US 2021/0018476 A1
(43) Pub. Date: Jan. 21, 2021

(54) SIZE EXCLUSION CHROMATOGRAPHY-COMBINED NITROGEN DETECTOR AND APPLICATION METHOD

(71) Applicants: NANJING UNIVERSITY, Nanjing (CN); ZHEJIANG TAILIN BIOENGINEERING CO., LTD, Hangzhou (CN)

(72) Inventors: Wentao LI, Nanjing (CN); Minhui CAI, Nanjing (CN); Dalin YE, Hangzhou (CN); Xinqun XIA, Hangzhou (CN); Yan LI, Nanjing (CN); Aimin LI, Nanjing (CN); Jichun WU, Nanjing (CN); Yanting ZUO, Nanjing (CN); Yaping WU, Nanjing (CN); Dawei LI, Nanjing (CN); Haiou SONG, Nanjing (CN)

(21) Appl. No.: 17/042,196

(22) PCT Filed: Apr. 2, 2019
(86) PCT No.: PCT/CN2019/080919

§ 371 Date: Sep. 28, 2020

(30) Foreign Application Priority Data
Apr. 19, 2018 (CN) 201810354795.4

(51) Int. Cl. G01N 30/88; G01N 30/74; G01N 21/33

(52) U.S. Cl. CPC G01N 30/88; G01N 30/74; G01N 2030/025; G01N 2030/8809; G01N 21/33

(57) ABSTRACT

Disclosed are a size exclusion chromatography-combined nitrogen detector and an application method thereof, which belong to the field of detection and analysis of water quality. The detector comprises an oxidation system (1), a nitrate detection system (2), a power supply system (3), and a signal processing and control system (4), wherein after being separated by size exclusion chromatography, a sample to be detected enters into the oxidation system (1) to undergo oxidation treatment, and after nitrogenous compound in the sample is converted into nitrate, the sample is detected in the nitrate detection system (2) by ultraviolet (UV) absorbance method. The power supply system (3) supplies power to the detector, and the signal processing and control system (4) is responsible for processing and controlling signals of the oxidation system (1) and the nitrate detection system (2). The detector can achieve quantitative analyses of total nitrogen, organic nitrogen, nitrate nitrogen, and ammonia nitrogen, has the advantages of easiness in operation, being rich in information, etc. and thereby effectively prevents the problems of relatively large error and negative value resulting from the subtraction calculation in conventional organic nitrogen analysis methods.

### CROSS REFERENCE TO RELATED APPLICATION

This application is a national stage application of International application number PCT/CN2019/080919, filed Apr. 2, 2019, titled “SIZE EXCLUSION CHROMATOGRAPHY-COMBINED NITROGEN DETECTOR AND APPLICATION METHOD,” which claims the priority benefit of Chinese Patent Application No. 201810354795.4, filed on Apr. 19, 2018, which is hereby incorporated by reference in its entirety.

### BACKGROUND

### Technical Field

The present invention relates to the field of detection and analysis of water quality, and specifically, to a size exclusion chromatography-combined nitrogen detector and an application method.

### Related Art

During the process of drinking water and wastewater treatment, dissolved organic matters are the main substances to be removed. Analysis and characterization of the composition and properties of dissolved organic matters is an important means for studying the mechanism of water treatment technology. Molecular weight distribution characteristic, as one of the important properties of dissolved organic matters, influences the effects of physiochemical treatment technologies such as coagulation, membrane filtration, advanced oxidation, absorption, and ion exchange.

Methods for analyzing and characterizing the molecular weight distribution characteristic mainly include membrane separation and size exclusion chromatography. Affected by the pore size of the ultrafiltration membrane, the membrane separation method has poor molecular weight separation accuracy. The size exclusion chromatography utilizes the size exclusion chromatography column, and the flow time of substances with different molecular weights is different, providing good separation effect. However, detectors configured for liquid chromatography are mainly ultraviolet (UV) absorption spectrum detectors, fluorescence spectrum detectors, and evaporative light scattering detectors. Due to the high heterogeneity of dissolved organic matters, the existing detectors can only allow relative quantitation. Dissolved organic carbon is a comprehensive indicator which indicates the total amount of dissolved organic matters in water by the carbon content. In recent years, organic carbon detectors based on membrane conductometric detection technique produced by GE is used in combination with the size exclusion chromatography, where organic carbon is mixed with an acid and oxidized to CO₂ by UV oxidation, the amount of CO₂ that permeates the membrane is measured, and thus the molecular weight distribution of organic carbon is measured.

As water bodies become more eutrophic, the presence and available forms of nitrogen, as an important nutrient, in water have become an important subject to be studied. Total dissolved nitrogen (TDN) in water bodies includes dissolved organic nitrogen (DON) and dissolved inorganic nitrogen (DIN). The DON comes from various natural organic materials such as protein, humus, and amino acid; the DIN mainly includes ammonia nitrogen, nitrate nitrogen, and nitrite nitrogen. The DON has direct or indirect toxic effects on human body, and especially, the DON can form nitrogen-containing sterilization byproducts having higher mutagenic, carcinogenic, and teratogenic effects in the chlorination process of drinking water. On the other hand, the molecular weight distribution of DON has important influence on the bioavailability and the eco-environmental effects thereof. Existing methods for measuring DON are mainly based on the subtraction method, that is, subtracting DIN (i.e., the sum of concentrations of NH₄⁺, NO₃⁻, and NO₂⁻ respectively measured) from the measured concentration of TDN. Such indirect measurement methods have accumulated errors in the measurement of total nitrogen, NH₄⁺, NO₃⁻, and N₂⁻, leading to inaccurate and unreliable results, or even making negative values due to the measurement errors.

In view of the above deficiencies, many researchers propose a method of separating DON and DIN prior to measurement, so as to increase the accuracy of concentration measurement. For example, Chinese Patent Application No. CN201010022653.1 published on Jul. 21, 2010 disclosed a method of separating DON by nanofiltration prior to measurement, however, due to the need to add nitrogen gas to control the trans-membrane pressure, this method had high energy consumption and a large demand for water samples. Chinese Patent Application No. CN201710048270.3 published on May 31, 2017 disclosed a method of separating DON by dialysis pretreatment prior to measurement. For this method, because the following measurement scheme needs to be determined based on the preliminary measurement result, the separation and measurement steps are complex, leading to complicated operations. In addition, the above methods for measuring DON only allow quantitative analysis, and do not perform in-depth qualitative and quantitative analysis of the composition and the molecular weight distribution of DON.

According to the National Standard GB 11894-89 of the People's Republic of China, the total nitrogen is obtained by measuring the concentration of NO₃⁻ by the UV spectrophotometry after oxidative digestion of potassium persulfate in an aqueous solution at 60° C. or above. Based on improvements on the standard total nitrogen measurement method, the present invention provides a size exclusion chromatography-combined nitrogen detector with high sensitivity and high accuracy and an application method thereof, so as to achieve the qualitative and quantitative analysis and measurement of DON.

### SUMMARY

### 1. Technical Problem To Be Solved

As the method for analyzing and measuring TON in the prior art has problems of low sensitivity, large error, and complicated measurement steps, an objective of the present invention is to provide a size exclusion chromatography-combined nitrogen detector with high sensitivity and high accuracy and an application method thereof.

### 2. Technical Solution

To solve the above problems, the present invention adopts the following technical solutions:

The present invention provides a size exclusion chromatography-combined nitrogen detector, including an oxidation system, a nitrate detection system, a power supply system, and a signal processing and control system, wherein after being separated by size exclusion chromatography, a sample to be detected enters into the oxidation system to undergo oxidation treatment, and after nitrogenous compound in the sample is converted into nitrate, the sample is detected in the nitrate detection system; the power supply system supplies power to the detector; and the signal processing and control system is configured to process and control signals of the oxidation system and the nitrate detection system.

As a further improvement of the present invention, the oxidation system includes an ultraviolet (UV) oxidation module and an UV light intensity monitoring module.

As a further improvement of the present invention, the oxidation system includes a leakage monitoring module and a vacuum negative pressure module, the vacuum negative pressure module being configured to remove ozone in the oxidation system and vacuumize the oxidation system.

As a further improvement of the present invention, the UV oxidation module includes an UV lamp, a spiral quartz tube flow path, quartz adapters, a PEEK (polyetheretherketone) coupling, a supporting bracket, and a quartz sleeve, the supporting bracket supports and secures the UV oxidation module to a base, the UV lamp is located inside the quartz sleeve, the spiral quartz tube flow path is spirally wound around the quartz sleeve, both ends of the spiral quartz tube flow path are respectively connected to one ends of the quartz adapters, and the other end of each of the quartz adapters is connected to the PEEK coupling.

In some embodiments, the UV oxidation module includes an UV lamp and a quartz microfluidic chip, the UV lamp is mounted on a surface of the quartz microfluidic chip, the quartz microfluidic chip is provided with an S-shaped microfluidic channel formed by etching, and preferably, the microfluidic channel has a cross-sectional width of 0.10-1.0 mm, a depth of 0.05-0.50 mm, and a flow path length of 2-10 m.

As a further improvement of the present invention, the nitrate detection system is an UV detector, including a flow cell module and an UV absorption optical detection module.

As a further improvement of the present invention, the power supply system includes an UV lamp-dedicated power supply and an AC-DC power conversion module, the UV lamp-dedicated power supply supplies power to the UV oxidation module, and the AC-DC power conversion module supplies power to the nitrate (NO₃⁻) detection system, the signal processing and control system, and the UV light intensity monitoring module.

As a further improvement of the present invention, the signal processing and control system includes a single-chip microcomputer system, a display, and a communication module, and the single-chip microcomputer system controls and processes a signal, which can be displayed on the display or transmitted to a host computer by the communication module.

It should be noted that, the articles “a” and “an” are used herein to refer to one or to more than one (i.e., to at least one) of the grammatical object of the article. By way of example, “an element” means one element or more than one element.

As a further improvement of the present invention, the UV light intensity monitoring module monitors light intensity of the UV oxidation module in real time by using an aluminum gallium nitride-based deep UV photodiode.

As a further improvement of the present invention, the UV lamp is a low-pressure mercury lamp, and the spiral quartz tube flow path is a quartz capillary tube with an inner diameter of 0.5-1.0 mm and an outer diameter of 1.5-3.0 mm.

As a further improvement of the present invention, provided is an application method of the size exclusion chromatography-combined nitrogen detector, including the following steps:

1) separating organic nitrogen, nitrate nitrogen (NO₃⁻_N), and ammonia nitrogen (NH₄⁺_N) by using a size exclusion chromatography column, wherein pure water or a phosphate buffered solution is used as the mobile phase, and an organic solvent cannot be used as the mobile phase;

2) connecting in parallel a PEEK tube of a specific length at both ends of the size exclusion chromatography column to form a PEEK tube bypass, and adjusting the length of the PEEK tube, so that a ratio of pressure produced by the PEEK tube bypass to pressure produced by the size exclusion chromatography column is n:1 (where n may be 5-15), and therefore, a ratio of a flow rate in the PEEK tube bypass to a flow rate in the size exclusion chromatography column is 1:n;

3) when an automatic sampler is injecting, the injected sample passes through the bypass and the size exclusion chromatography column at a ratio of 1:10, and then being detected by the nitrogen detector, where peaks elute quickly because the bypass has no retention function, with a peak area thereof being denoted as Area_TN; after the separation by size exclusion chromatography, respectively integrating peaks of organic nitrogen, NO₃⁻, and NH₄⁺, with peak areas being respectively denoted as Area_TON, Area_NO₃⁻_N, and Area_NH₄⁺_N; and

4) establishing a linear relationship between the peak area Area_TN and nitrogen content by using NO₃⁻ standard solution, calculating total nitrogen (TN) based on the bypass Area_TN of the sample, and calculating concentrations of total organic nitrogen (TON), nitrate nitrogen (NO₃⁻_N), and ammonia nitrogen (NH₄⁺_N) based on percentages of Area_TON, Area_NO₃⁻_N, and Area_NH₄⁺_N in a total peak area of the size exclusion chromatography.

### 3. Beneficial Effects

Compared with the prior art, the beneficial effects of the present invention are as follows:

(1) In the size exclusion chromatography-combined nitrogen detector according to the present invention, nitrogen in compounds separated by size exclusion chromatography is oxidized to nitrate by using the oxidation system, and then nitrate is detected, which therefore can achieve accurate quantitative analysis of total nitrogen, nitrate nitrogen, nitrite nitrogen, and ammonia nitrogen in various compounds and provide accurate and reliable results, thereby overcoming the deficiencies of complex operational steps and large error of the prior-art organic nitrogen measurement methods which require the use of different methods to respectively measure total nitrogen, nitrate nitrogen, nitrite nitrogen, and ammonia nitrogen followed by the calculation of the difference between total nitrogen and total inorganic nitrogen. In addition, the detector of the present invention can be used in combination with a constant flow pump, an automatic sampler, and a size exclusion chromatography column commonly seen in laboratories, featuring low costs and convenient system integration, and being easy to promote.

(2) In the size exclusion chromatography-combined nitrogen detector according to the present invention, the oxidation system includes an UV oxidation module and an UV light intensity monitoring module. The UV oxidation module is configured to oxidize nitrogen in compounds to nitrate ion. The UV light intensity monitoring module is configured to monitor the UV light intensity of the UV oxidation module in real time. The cooperation of the two modules ensures enough oxidation strength of the oxidation system, thereby ensuring a stable and effective oxidation effect.

(3) In the size exclusion chromatography-combined nitrogen detector according to the present invention, the oxidation system can further include a vacuum negative pressure module, and the vacuum negative pressure module not only removes ozone produced from UV irradiation in air, but also reduces the attenuation of UV light intensity through vacuumization to enhance the oxidation effect, thereby further ensuring a stable and effective oxidation effect of the oxidation system.

(4) In the size exclusion chromatography-combined nitrogen detector according to the present invention, the power supply system can set different power supply according to the different characteristics of the UV oxidation module and other modules, thereby reducing power consumption and further reducing operating costs.

(5) In the application method of the size exclusion chromatography-combined nitrogen detector according to the present invention, two different flow paths are set: a bypass and a size exclusion chromatography column flow path. As the bypass does not have a retention function, the peak area thereof is denoted as Area_TN. The peaks of TON, NO₃⁻, NH₄⁺ separated by size exclusion chromatography are respectively integrated, and percentages of Area_TON, Area NO₃⁻_N, and Area_NH₄⁺_N in Area_TN are calculated. Then, a linear relationship between the peak area Area_TN and nitrogen content is established by using NO₃⁻ standard solution, and finally the concentrations of various forms of nitrogen are calculated. By additionally setting a bypass to finally achieve the accurate quantitative measurement of various forms of nitrogen, the method is easy to operate and promote, and features low costs, accurate and reliable results, and high sensitivity.

(6) In the application method of the size exclusion chromatography-combined nitrogen detector according to the present invention, the final quantitative analysis is determined according to total nitrogen and the percentage for which the peak area of organic nitrogen accounts, and no negative value will be obtained, thereby further ensuring the accuracy of the results, while in the prior art, the difference is calculated, which leads to a large error.

(7) In the application method of the size exclusion chromatography-combined nitrogen detector according to the present invention, by separating substances with different molecular weights by size exclusion chromatography, the molecular weight distribution of organic nitrogen can be qualitatively analyzed, and more characterization information can be provided, which is especially suitable for laboratory scientific research.

### BRIEF DESCRIPTION OF THE DRAWINGS

FIG. 1 is a top view of the size exclusion chromatography-combined nitrogen detector according to the present invention;

FIG. 2 is a front view of the oxidation module with spiral tube in the size exclusion chromatography-combined nitrogen detector according to the present invention;

FIG. 3 is a top view of the oxidation module with spiral tube in the size exclusion chromatography-combined nitrogen detector according to the present invention;

FIG. 4 is a flow diagram showing the application method of the nitrogen detector according to the present invention;

FIG. 5 is a diagram showing a linear relationship between the peak area Area_TN and nitrogen content, which is established by using NO₃⁻ standard solution;

FIG. 6 is a chromatogram of an effluent sample after the secondary biochemical treatment of a wastewater plant as detected by the size exclusion chromatography-combined nitrogen detector according to the present invention;

FIG. 7 is a chromatogram of a water sample from Yangtze River as detected by the size exclusion chromatography-combined nitrogen detector according to the present invention;

FIG. 8 is a test diagram showing the oxidation efficiency of the size exclusion chromatography-combined nitrogen detector according to the present invention; and

FIG. 9 is a schematic diagram of the oxidation module with microfluidic chip in the size exclusion chromatography-combined nitrogen detector according to the present invention.

In the drawings: 1. oxidation system; 2. nitrate detection module; 3. power control module; 4. signal processing and control system; 5. phosphate buffered solution; 6. ultrapure water; 7. constant flow pump; 8. automatic sampler; 9. size exclusion chromatography column; 10. bypass PEEK tube; 11. syringe pump; 12. size exclusion chromatography-combined nitrogen detector; 101. UV oxidation module; 102. leakage monitoring module; 103. UV light intensity monitoring module; 104. vacuum negative pressure module; 201. flow cell module; 202. UV absorption optical detection module; 301. UV lamp-dedicated power supply; 302. AC-DC power conversion module; 401. single-chip microcomputer system; 402. display; 403. communication module; 111. UV lamp; 112. spiral quartz tube flow path; 113. quartz adapter; 114. PEEK coupling; 115. supporting bracket; 116. quartz sleeve; 117. quartz microfluidic chip.

### DETAILED DESCRIPTION

The present invention is described in detail below with reference to specific examples.

### Example 1

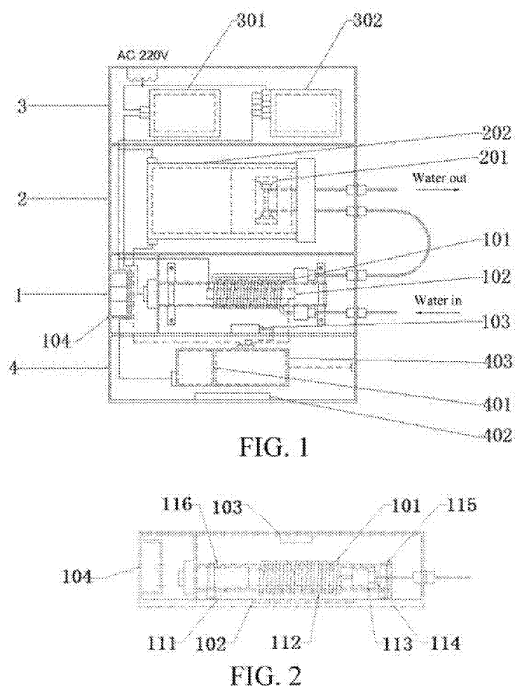

This example provides a size exclusion chromatography-combined nitrogen detector. As shown in FIG. 1, the detector includes an oxidation system 1, a nitrate detection system 2, a power supply system 3, and a signal processing and control system 4. A sample to be detected is first separated by size exclusion chromatography and then enters into the oxidation system 1 to undergo the oxidation treatment, and after nitrogenous compound in the sample is converted into nitrate, the sample is detected in the nitrate detection system 2. The power supply system 3 supplies power to the detector. The signal processing and control system 4 is configured to process and control signals of the oxidation system 1 and the nitrate detection system 2.

The basic principle of the detector of the present invention is using the oxidation system 1 to convert nitrogen contained in various compounds after separation by size exclusion chromatography into NO₃⁻, and carrying out a quantitative measurement according to molar absorption coefficient or absorption coefficient per unit mass of NO₃⁻ at a specific UV wavelength.

The oxidation system 1 includes an UV oxidation module 101 and an UV light intensity monitoring module 103. The UV oxidation module 101 oxidizes a compound by UV light oxidation to convert nitrogen in the compound into NO₃⁻. The UV light intensity monitoring module 103 is configured to monitor the intensity of UV light generated by the UV oxidation module 101 in real time. The signal processing and control system 4 is configured to control signals generated, so as to ensure that the UV oxidation module 101 provides enough oxidation strength.

The oxidation system 1 further includes a vacuum negative pressure module 104. The vacuum negative pressure module 104 removes ozone produced by UV irradiation in air from the detector, and vacuumizes to enhance the UV oxidation effect. The vacuum negative pressure module 104 is specifically a micro vacuum pump, which includes an activated carbon filter disposed at the suction inlet thereof to remove ozone.

The oxidation system 1 further includes a leakage monitoring module 102. The leakage monitoring module 102 is configured to monitor the leakage status of the system and is controlled by the signal processing and control system 4. The leakage monitoring module 102 uses a LeakFilm sensor strip, can respond to the liquid leakage quickly without false alarm, and can be quickly reset to enter the working state after the leakage is cleared.

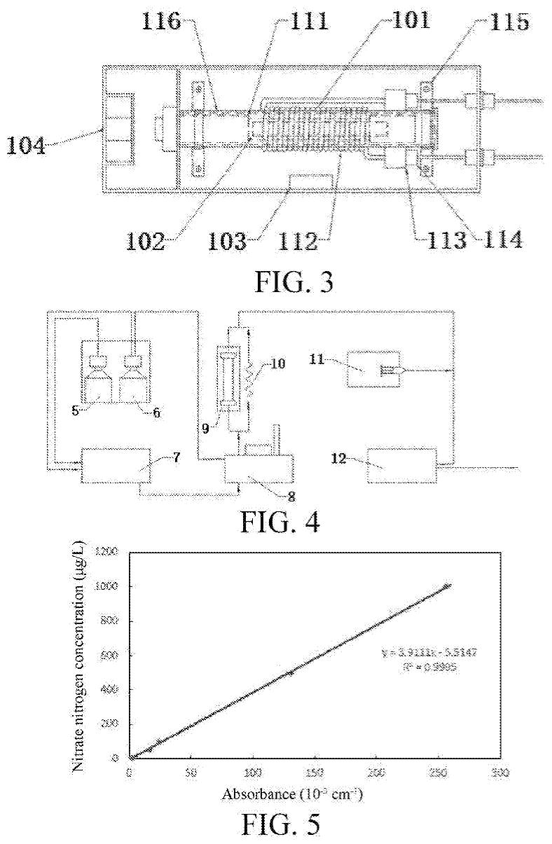

As shown in FIG. 2 and FIG. 3, the UV oxidation module 101 converts nitrogen in various compounds therein into NO₃⁻, the leakage monitoring module 102 is configured to monitor the leakage status, and the leakage status is displayed through the signal processing and control system 4; and the UV light intensity monitoring module 103 displays the UV light intensity through the signal processing and control system 4.

### Example 2

This example is basically the same as Example 1 with differences as follows:

The nitrate detection system 2 is an UV detector, including a flow cell module 201 and an UV absorption optical detection module 202. Its working principle is using a continuous light source such as a deuterium lamp or UV_LED lamp to emit UV light having a specific wavelength, measuring UV absorbance of the mobile phase of the size exclusion chromatography over a wavelength range of 215-230 nm in a flow cell with an optical path of 10-40 nm, and quantifying NO₃⁻ according to the molar absorption coefficient or absorption coefficient per unit mass of NO₃⁻ at the corresponding wavelength.

The nitrate detection system 2 is the outlet of the flow path, where the flow cell module 201 carries out the quantitative measurement according to the molar absorption coefficient or the absorption coefficient per unit mass of NO₃⁻ at the specific UV wavelength and emits an optical signal, and the UV absorption optical detection module 202 converts the optical signal into an electrical signal, which is then transmitted to the signal processing and control system 4.

The optical path of the flow cell module 201 is 10 mm, NO₃⁻ is quantitatively measured by using UV absorbance at the wavelength of 220 nm, and the absorption coefficient per unit mass is 0.25 L/(mg*cm).

The signal processing and control system 4 includes a single-chip microcomputer system 401, a display 402, and a communication module 403. The single-chip microcomputer system 401 controls and processes a signal, which can be displayed on the display 402 or transmitted by the communication module 403 to a host computer.

The electrical signal generated by the UV absorption optical detection module 202 is processed by an amplification circuit and an analog-to-digital conversion circuit to generate a digital signal, which is transmitted to the single-chip microcomputer system 401. The single-chip microcomputer system 401 stores the digital signal in a single-chip microcomputer. The display 402 displays the digital signal and the basic status of the device in real time.

The single-chip microcomputer system 401 outputs a communication signal to the oxidation system 1, so as to control the UV oxidation module 101 in the oxidation system 1 to work in a continuous manner.

### Example 3

This example is basically the same as Example 1 with differences as follows:

The UV light intensity monitoring module 103 monitors the light intensity of the UV oxidation module 101 in real time by using an aluminum gallium nitride-based deep UV photodiode, and responds only to UV light in the UVC band.

The power supply system 3 includes an UV lamp-dedicated power supply 301 and an AC-DC power conversion module 302. The UV lamp-dedicated power supply 301 supplies power to the UV oxidation module 101. The AC-DC power conversion module 302 supplies power to the nitrate (NO₃⁻) detection system 2, the signal processing and control system 4, and the UV light intensity monitoring module 103.

The reason why the UV oxidation module 101 and other modules are powered by different power supplies is that: the UV lamp used in the UV oxidation module 101 is a low-power cold-cathode lamp, which is suitable for an AC-to-DC or DC-to-AC power supply mode; while hot-cathode lamps used in other modules have high supply power, so a standard AC power supply with variable frequency and variable voltage is provide. Therefore, the use of different power supply systems for the UV oxidation module 101 and other modules can reduce power consumption and further reduce operating costs.

### Example 4

This example is basically the same as Example 1 with differences as follows:

The UV oxidation module 101 includes an UV lamp 111, a spiral quartz tube flow path 112, quartz adapters 113, a PEEK coupling 114, a supporting bracket 115, and a quartz sleeve 116. FIG. 2 is a front view of the UV oxidation module 101 of this example; FIG. 3 is a top view of the UV oxidation module 101 of this example. As shown in FIG. 2 and FIG. 3, the supporting bracket 115 supports and secures the UV oxidation module 101 to a base by using a plastic retaining ring with an inner diameter of 25 mm. The UV lamp 111 is located inside the quartz sleeve 116. The quartz sleeve 116 protects the UV lamp 111 and fixes the spiral quartz tube flow path 112. The spiral quartz tube flow path 112 is a quartz capillary tube with an inner diameter of 1.0 mm and an outer diameter of 3.0 mm wound around the quartz sleeve 116 by melting. Two ends of the quartz capillary tube are connected to one ends of two quartz adapters 113 by melting, and the other end of each of the quartz adapters is provided with ¼″-28 internal threads that can be connected to a PEEK coupling 114 of the same specification. The PEEK coupling 114 and the PEEK tube connected thereto is only used for transporting liquid and have no other special function.

The sample after separation flows in the spiral quartz tube and is irradiated to be oxidized by the UV. The parts of sample, after respectively flowing through the size exclusion chromatography column and the bypass, combine into one path again. Then the influent in the oxidation module enters the spiral quartz tube flow path through a PEEK wall coupling and the quartz adapter and is oxidized therein, then enters the detection module through the quartz adapter, a PEEK wall coupling, and the PEEK tube, flows out of the detector through an effluent port of the detector after testing, and is discharged through an effluent tube.

The UV lamp 111 is a low-pressure cold-cathode lamp with a diameter of 15 mm and a length of 150 mm. The UV spectrum generated by the UV lamp 111 includes two UV rays with wavelengths of 184.9 nm and 253.7 nm, where the UV ray with the wavelength of 184.9 nm is dominant in the oxidation process of nitrogen.

### Example 5

This example provides a process of sample detection by using the size exclusion chromatography-combined nitrogen detector of Example 1. FIG. 4 is a flow diagram showing the process of sample detection. As shown in FIG. 4, the entire process includes the following steps:

a) using an automatic sampler 8 to inject a sample into a phosphate buffered solution 5, which is a mobile phase driven by a multi-channel constant flow pump 7;

b) the sample entering the size exclusion chromatography-combined nitrogen detector 12 respectively through two flow paths: a size exclusion chromatography column 9 and a bypass PEEK tube 10, where the size exclusion chromatography column 9 has a length of 250 mm and an inner diameter of 20 mm, and is filled with Toyopearl HW-50S resin;

c) before the sample enters the size exclusion chromatography-combined nitrogen detector 12, introducing a potassium persulfate solution with a mass concentration of 1% as an oxidizing agent by using a syringe pump 11, where the oxidizing agent can enhance the oxidation effect for high-concentration water samples; and

d) after the sample detection is completed, washing the tubes with ultrapure water 6.

This example also provides an application method of the size exclusion chromatography-combined nitrogen detector of Example 1 for sample detection, including the following steps:

1) separating TON, NO₃⁻, and NH₄⁺ in the sample by using a size exclusion chromatography column, with the mobile phase being a phosphate buffered solution, which is a mixture of 2.5 g/L KH₂PO₄ and 1.5 g/L Na₂HPO₄.2H₂O;

2) connecting in parallel a segment of PEEK tube at two ends of the size exclusion chromatography column by using three-way joints to form a bypass, and adjusting the length of the PEEK tube so that a ratio of pressure produced by the bypass PEEK tube 10 to pressure produced by the size exclusion chromatography column is 10:1, and therefore, a ratio of a flow rate in the bypass to a flow rate in the size exclusion chromatography column is 1:10;

3) taking 500 μL of a sample from an effluent of the secondary biochemical treatment of a wastewater plant, passing the sample respectively through the bypass and the size exclusion chromatography column at a ratio of 1:10, and then detecting the sample in the nitrogen detector, where peaks elute quickly because the bypass has no retention function, with a peak area thereof being denoted as Area_TN; after the separation by size exclusion chromatography, respectively integrating peaks of TON, NO₃⁻, and NH₄⁺, with peak areas thereof being respectively denoted as Area_TON, Area_NO₃⁻_N, and Area_NH₄⁺_N, measured in AU (Arbitrary Units); and

4) establishing a linear relationship between the peak area Area_TN and nitrogen content by using NO₃⁻ standard solution, calculating total nitrogen (TN) according to the bypass Area_ TN of the sample, and calculating concentrations of total organic nitrogen (TON), nitrate (NO₃⁻_N), and ammonium (NH₄⁺_N) according to percentages of Area_TON, Area_NO₃⁻_N, and Area_NH₄⁺_N in a total peak area of the size exclusion chromatography.

When the linear relationship is established, NO₃⁻ standard solution with nitrogen concentrations of 1 mg/L, 500 μg/L, 100 μg/L, 10 μg/L, and 5 μg/L are respectively prepared and sampled, and a linear relationship between the peak area Area_TN and nitrogen content is established. FIG. 5 is a diagram showing a linear relationship between the peak area Area_TN and nitrogen content, which is established by using NO₃⁻ standard solution. As can be seen from FIG. 5, in the linear equation between the peak area Area_TN and nitrogen content, R²=0.9995, which meets the criteria for linearity.

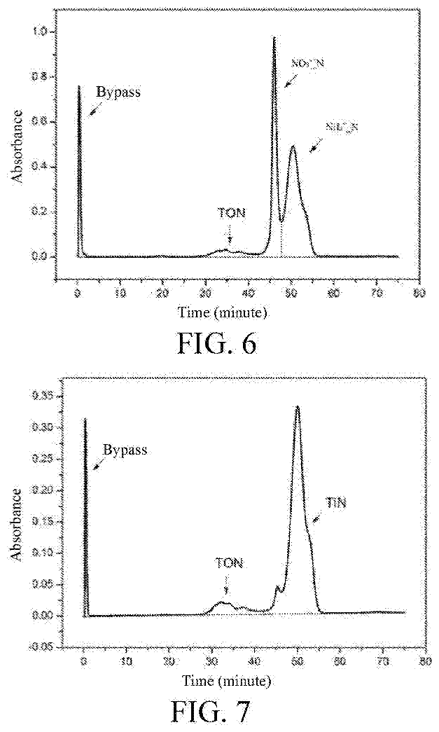

FIG. 6 is a chromatogram of an effluent sample of the secondary biochemical treatment of a wastewater plant as detected by the size exclusion chromatography-combined nitrogen detector of the present invention, where Bypass represents the peak of the TN of the bypass; TON, Area_NO₃⁻_N, and Area_NH₄⁺_N respectively represent the peaks of TON, NO₃⁻_N, and NH₄⁺_N through the size exclusion chromatography column. The calculation processes of the concentrations of

TN, TON, NO₃⁻_N, and NH₄⁺_N are as follows:

The concentration of TN is: 0.367 AU×1.1 mL/min×3.911 mg·cm/L×11÷0.5 mL=34.735 mg/L

The concentration of TON is: 34.735 mg/L×(0.261÷0.367 )÷10=2.470 mg/L

The concentration of NO₃⁻_N is: 34.735 mg/L×(1.338÷0.367 )÷10=12.636 mg/L

The concentration of NH₄⁺_N is: 34.735 mg/L×(2.069÷0.367 )÷10=19.582 mg/L

Table 1 shows statistics on the final test results.

TABLE 1
Test results

| Component | TN | TON | NO₃⁻_N | NH₄⁺_N |
|---|---|---|---|---|
| Integration area | 0.367 | 0.261 | 1.338 | 2.069 |
| (arbitrary unit, AU) | | | | |
| Concentration (mg/L) | 34.735 | 2.470 | 12.636 | 19.582 |

### Example 6

This example is basically the same as Example 5 except that: the water sample to be detected is from Yangtze River with a sampling volume of 500 μL, the oxidation method is only UV oxidation and no oxidizing agent is added by using the syringe pump 11. The sum of nitrate (NO₃⁻_N) and ammonium (NR₄⁺_N) is denoted as total inorganic nitrogen (TIN). The calculation processes of the concentrations of TN, TON, NO₃⁻_N, and NH₄⁺_N are the same as those in Example 5. Table 2 shows statistics on the test results of this example.

TABLE 2
Test results

| Component | TN | TON | TIN |
|---|---|---|---|
| Integration area (AU) | 0.166 | 0.199 | 1.460 |
| Concentration (mg/L) | 16.069 | 1.926 | 14.133 |

### Example 7

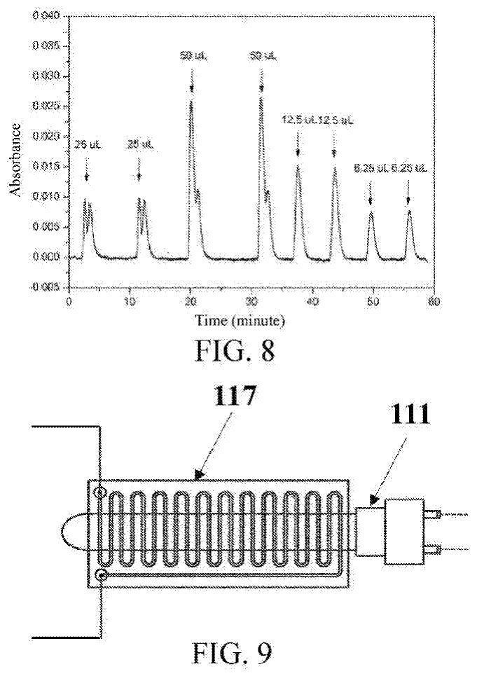

This example is basically the same as Example 6 except that: in this example, the size exclusion chromatography column 9 and the bypass PEEK tube 10 are not used, and 25 μL, 50 μL, 12.5 μL, and 6.25 μL of 100 mg/L bovine serum albumin aqueous solution are respectively injected twice, for the purpose of determining the oxidation efficiency. FIG. 8 is a test diagram showing the oxidation efficiency of the size exclusion chromatography-combined nitrogen detector according to the present invention. As shown in FIG. 8, the peaks of solutions with sample volumes of 25 μL and 50 μL are bifurcated, indicating that the sample volume exceeds the oxidation capacity of the UV spiral tube, while the peaks of solutions with sample volumes of 12.5 μL and 6.25 μL have good peak shape, and the peak area of one of the solutions is 2 times that of the other, indicating that the UV oxidation module 101 can fully oxidize

TON in such sample volumes.

### Example 8

In this example, the size exclusion chromatography column 9 and the bypass PEEK tube 10 are not used, and TON_N, NO₃⁻_N, and NH₄⁺_N solutions with nitrogen concentration of 10 mg/L are prepared by using bovine serum albumin, NaNO₃, and NH₄Cl, and respectively injected 5 times. The relative standard deviations are all less than 2% and satisfy the accuracy requirements. Table 3 shows statistics on the test results.

TABLE 3
Test results

| | | | | | | | Relative |
|---|---|---|---|---|---|---|---|
| Injected | | | | | | | standard |
| material | 1^{st} time | 2^{nd} time | 3^{rd} time | 4^{th} time | 5^{th} time | Mean | deviation |
| TON_N | 9.877 | 9.932 | 9.831 | 9.841 | 10.234 | 9.943 | 1.68% |
| NO₃⁻_N | 10.031 | 10.053 | 10.042 | 10.073 | 10.043 | 10.048 | 0.16% |
| NH₄⁺_N | 9.981 | 9.874 | 9.865 | 9.742 | 9.832 | 9.859 | 0.87% |

The unit of numbers in this table is mg/L, except for the relative standard deviations.

At the same time, according to the method in Example 6, by using the size exclusion chromatography column 9 and the bypass PEEK tube 10, the prepared TON_N, NO₃⁻_N, and NH₄⁺_N solutions with the nitrogen concentration of 10 mg/L are respectively injected. The relative standard deviations are all less than 2% and satisfy the accuracy requirements. Table 4 shows statistics on the test results according to the method of the present invention.

TABLE 4
Test results

| | | | | | | | Relative |
|---|---|---|---|---|---|---|---|
| Injected | | | | | | | standard |
| material | 1^{st} time | 2^{nd} time | 3^{rd} time | 4^{th} time | 5^{th} time | Mean | deviation |
| TON_N | 9.775 | 9.887 | 9.834 | 10.247 | 9.974 | 9.943 | 1.86% |
| NO₃⁻_N | 10.054 | 9.985 | 9.847 | 10.107 | 10.043 | 10.007 | 0.99% |
| NH₄⁺_N | 9.752 | 10.124 | 9.756 | 9.854 | 9.854 | 9.868 | 1.54% |

As can be seen from the results in Table 4, the method of the present invention is accurate and reliable.

### Example 9

This example is basically the same as Example 5 except that: the ratio of the flow rate in the bypass 10 to the flow rate in the size exclusion chromatography column 9 is 1:5.

The spiral quartz tube flow path 112 is a quartz capillary tube with an inner diameter of 0.5 mm and an outer diameter of 1.5 mm.

### Example 10

This example is basically the same as Example 5 except that the ratio of the flow rate in the bypass 10 to the flow rate in the size exclusion chromatography column 9 is 1:15.

As shown in FIG. 9, the UV oxidation module 101 includes an UV lamp 111 and a quartz microfluidic chip 117. The UV lamp 111 is mounted on a surface of the quartz microfluidic chip 117. The quartz microfluidic chip 117 is provided with an S-shaped microfluidic channel formed by etching. The microfluidic channel has a cross-sectional width of 0.40 mm, a depth of 0.10 mm, and a flow path length of 4 m.

Although the present invention and the implementations of the present invention have been schematically described above, such description is not limiting. The accompanying drawings shows only one of the implementations of the present invention, and the actual flow is not limited thereto. Therefore, any structure or embodiment similar to this technical solution designed without creative efforts by those of ordinary skill in the art based on the teaching of the present invention and without departing from the spirit of the present invention shall fall within the scope of protection of the present invention.

What is claimed is:

1. size exclusion chromatography-combined nitrogen detector, comprising: an oxidation system (1), a nitrate detection system (2), a power supply system (3), and a signal processing and control system (4), wherein a sample to be detected is first separated by size exclusion chromatography and then enters into the oxidation system (1) to undergo oxidation treatment, and after nitrogenous compound in the sample is converted into nitrate, the sample is detected in the nitrate detection system (2); the power supply system (3) supplies power to the detector; and the signal processing and control system (4) is configured to process and control signals of the oxidation system (1) and the nitrate detection system (2).

2. The size exclusion chromatography-combined nitrogen detector according to claim 1, wherein the oxidation system (1) comprises an ultraviolet (UV) oxidation module (101) and an UV light intensity monitoring module (103).

3. The size exclusion chromatography-combined nitrogen detector according to claim 1, wherein the oxidation system (1) comprises a leakage monitoring module (102) and a vacuum negative pressure module (104), the vacuum negative pressure module (104) being configured to remove ozone in the oxidation system (1) and vacuumize the oxidation system (1).

4. The size exclusion chromatography-combined nitrogen detector according to claim 3, wherein the UV oxidation module (101) comprises an UV lamp (111), a spiral quartz tube flow path (112), quartz adapters (113), a PEEK coupling (114), a supporting bracket (115), and a quartz sleeve (116), the supporting bracket (115) supports and secures the UV oxidation module (101) to a base, the UV lamp (111) is located inside the quartz sleeve (116), the spiral quartz tube flow path (112) is spirally wound around the quartz sleeve (116), both ends of the spiral quartz tube flow path (112) are respectively connected to one ends of the quartz adapters (113), and the other end of each of the quartz adapters (113) is connected to the PEEK coupling (114).

5. The size exclusion chromatography-combined nitrogen detector according to claim 1, wherein the nitrate detection system (2) is an UV detector, comprising a flow cell module (201) and an UV absorption optical detection module (202).

6. The size exclusion chromatography-combined nitrogen detector according to claim 2, wherein the power supply system (3) comprises an UV lamp-dedicated power supply (301) and an AC-DC power conversion module (302), the UV lamp-dedicated power supply (301) supplies power to the UV oxidation module (101), and the AC-DC power conversion module (302) supplies power to the nitrate (NO₃⁻) detection system (2), the signal processing and control system (4), and the UV light intensity monitoring module (103).

7. The size exclusion chromatography-combined nitrogen detector according to claim 4, wherein the signal processing and control system (4) comprises a single-chip microcomputer system (401), a display (402), and a communication module (403), and the single-chip microcomputer system (401) controls and processes a signal, which can be displayed on the display (402) or transmitted to a host computer by the communication module (403).

8. The size exclusion chromatography-combined nitrogen detector according to claim 1, wherein the UV light intensity monitoring module (103) monitors light intensity of the UV oxidation module (101) in real time by using an aluminum gallium nitride-based deep UV photodiode.

9. The size exclusion chromatography-combined nitrogen detector according to claim 4, wherein the UV lamp (111) is a low-pressure mercury lamp, and the spiral quartz tube flow path (112) is a quartz capillary tube with an inner diameter of 0.5-1.0 mm and an outer diameter of 1.5-3.0 mm.

10. An application method of the size exclusion chromatography-combined nitrogen detector according to claim 1, comprising the following steps:
1) separating organic nitrogen, nitrate nitrogen (NO₃⁻_N), and ammonia nitrogen (NH₄⁺_N) by using a size exclusion chromatography column (9);
2) connecting in parallel a PEEK tube of a specific length at both ends of the size exclusion chromatography column (9) to form a PEEK tube bypass (10), and adjusting the length of the PEEK tube, so that a ratio of pressure produced by the PEEK tube bypass (10) to pressure produced by the size exclusion chromatography column (9) is n:1;
3) when an automatic sampler (8) is injecting, the injected sample respectively passing through the PEEK tube bypass (10) and the size exclusion chromatography column (9) at a ratio of 1:10, and then being detected by the size exclusion chromatography-combined nitrogen detector (12), with a bypass peak area being denoted as Area_TN; after the separation by size exclusion chromatography, respectively integrating peaks of organic nitrogen, NO₃⁻, and NH₄⁺, with peak areas being respectively denoted as Area_TON, Area_NO₃⁻_N, and Area_NH₄⁺_N; and
4) establishing a linear relationship between the peak area Area_TN and nitrogen content by using NO₃⁻ standard solution, calculating total nitrogen (TN) based on the bypass Area_TN of the sample, and calculating concentrations of total organic nitrogen (TON), nitrate nitrogen (NO₃⁻_N), and ammonia nitrogen (NH₄⁺_N) based on percentages of Area_TON, Area_NO₃⁻_N, and Area_NH₄⁺_N in a total peak area of the size exclusion chromatography.

11. The size exclusion chromatography-combined nitrogen detector according to claim 2, wherein the UV oxidation module (101) comprises an UV lamp (111) and a quartz microfluidic chip (117), the UV lamp (111) is mounted on a surface of the quartz microfluidic chip (117), the quartz microfluidic chip (117) is provided with an S-shaped microfluidic channel formed by etching, and preferably, the microfluidic channel has a cross-sectional width of 0.10-1.0 mm, a depth of 0.05-0.50 mm, and a flow path length of 2-10 m.

12. The size exclusion chromatography-combined nitrogen detector according to claim 2, wherein the oxidation system (1) comprises a leakage monitoring module (102) and a vacuum negative pressure module (104), the vacuum negative pressure module (104) being configured to remove ozone in the oxidation system (1) and vacuumize the oxidation system (1).

13. The size exclusion chromatography-combined nitrogen detector according to claim 12, wherein the UV oxidation module (101) comprises an UV lamp (111), a spiral quartz tube flow path (112), quartz adapters (113), a PEEK coupling (114), a supporting bracket (115), and a quartz sleeve (116), the supporting bracket (115) supports and secures the UV oxidation module (101) so a base, the UV lamp (111) is located inside the quartz sleeve (116), the spiral quartz tube flow path (112) is spirally sound around the quartz sleeve (116), both ends of the spiral quartz tube flow path (112) are respectively connected to one ends of the quartz adapters (113), and the other end of each of the quartz adapters (113) is connected to the PEEK coupling (114).

14. The size exclusion chromatography-combined nitrogen detector according to claim 5, wherein the signal processing and control system (4) comprises a (403), and the single-chip microcomputer system (401) controls and processes a signal, which can be displayed on the display (402) or transmitted to a host computer by the communication module (403).

15. The size exclusion chromatography-combined nitrogen detector according to claim 12, wherein the signal processing and control system (4) comprises a single-chip microcomputer system (401), a display (402), and a communication module (403), and the single-chip microcomputer system (401) controls and processes a signal, which can be displayed on the display (402) or transmitted to a host computer by the communication module (403).

16. The size exclusion chromatography-combined nitrogen detector according to claim 2, wherein the UV light intensity monitoring module (103) monitors light intensity of the UV oxidation module (101) in real time by using an aluminum gallium nitride-based deep UV photodiode.

17. The size exclusion chromatography-combined nitrogen detector according to claim 5, wherein the UV lamp (111) is a low-pressure mercury lamp, and the spiral quartz tube flow path (112) is a quartz capillary tube with an inner diameter of 0.5-1.0 mm and an outer diameter of 1.5-3.0 mm.

18. The size exclusion chromatography-combined nitrogen detector according to claim 12, wherein the UV lamp (111) is a low-pressure mercury lamp, and the spiral quartz tube flow path (112) is a quartz capillary tube with an inner diameter of 0.5-1.0 mm and an outer diameter of 1.5-3.0 mm.
